(19) United States
(12) Patent Application Publication
(10) Pub. No.: US 2009/0028682 A1
(43) Pub. Date: Jan. 29, 2009

(54) GRIPPING APPARATUS FOR A FORK OF A FORK LIFT

(75) Inventor: Thomas Owen Monroe, JR., Troy, MI (US)

Correspondence Address: HARNESS, DICKEY & PIERCE, P.L.C., P.O. BOX 828, BLOOMFIELD HILLS, MI, 48303, US

(73) Assignee: AUTOMATED PRODUCTION ASSEMBLIES, INC., Fraser, MI (US)

(21) Appl. No.: 12/177,236

(22) Filed: Jul. 22, 2008

Related U.S. Application Data
(60) Provisional application No. 60/951,277, filed on Jul. 23, 2007.

(51) Int. Cl. B66F 9/18

(52) U.S. Cl. 414/661; 414/607

(57) ABSTRACT

A gripping apparatus for a fork of a fork lift includes a gripping portion and at least one mounting portion for removably securing the gripping apparatus to the fork. Openings are formed between the at least one mounting portion and the gripping portion for receiving the fork therethrough. The gripping apparatus is constructed of a high friction material.

### CROSS-REFERENCE TO RELATED APPLICATIONS

This application claims priority to U.S. Provisional Patent Application No. 60/951,277 filed 23 Jul. 2007 which application is herein expressly incorporated by reference as if fully set forth herein.

### FIELD

The present disclosure generally relates to the transfer of loads with a fork lift. More particularly, the present disclosure relates to a gripping apparatus for a fork of a fork lift.

### BACKGROUND

Pallets and other loads are conventionally transferred with a fork lift. A fork lift includes a pair of forwardly extending forks or arms used to raise and support such items for transfer. The arms slide under the item to be moved and engage an underside. Most typically, the arms extend substantially below a pallet or other load such that the fork lift may support the load. In some circumstances, the load may be positioned such that the arms cannot sufficiently reach thereunder to raise the load. In such circumstances, it may be desirable to engage the load with the arms and drag the load to a more suitable location (e.g., a location at which the arms may sufficiently reach underneath the load). Dragging of the load is often problematic given the low friction nature of conventional fork lift forks.

Accordingly, a need for continuous improvement in the pertinent art exists.

### SUMMARY

According to one particular aspect, the present teachings provide a gripping apparatus for a fork of a fork lift. The gripping apparatus includes a gripping portion and at least one mounting portion for removably securing the gripping apparatus to the fork. Openings are formed between the at least one mounting portion and the gripping portion for receiving the fork therethrough. The gripping apparatus is constructed of a high friction material.

According to another particular aspect, the present teachings provide a gripping apparatus for a fork of a fork lift. The gripping apparatus includes a gripping portion and at least one mounting portion. The at least one mounting portion cooperates with the gripping portion to at least partially define a channel for receiving the fork. The gripping apparatus is constructed of a high friction material.

According to yet another particular aspect, the present teachings provide a gripping apparatus for a fork of a fork lift. The gripping apparatus includes a main body portion having an upper surface and a lower surface. The upper surface is a high friction surface. The lower surface is a magnetic surface.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a top view of a gripping apparatus in accordance with the teachings of the present disclosure, the gripping apparatus shown operatively associated with a fork of a fork lift.

FIG. 2 is a bottom view of the gripping apparatus in accordance with the teachings of the present disclosure, the gripping apparatus again shown operatively associated with a fork of a fork lift.

FIG. 3 is a side view of the gripping apparatus in accordance with the teachings of the present disclosure, the gripping apparatus again shown operatively associated with a fork of a fork lift.

FIG. 4 is an enlarged top view of the gripping apparatus in accordance with the teachings of the present disclosure, the gripping apparatus shown removed from the fork of the fork lift for purposes of illustration.

FIG. 5 is an enlarged top view of another gripping apparatus in accordance with the teachings of the present disclosure.

FIG. 6 is an enlarged top view of another gripping apparatus in accordance with the teachings of the present disclosure.

FIG. 7 is a top view of another gripping apparatus for a fork of a fork lift in accordance with the teachings of the present disclosure, the gripping apparatus shown operatively associated with a fork.

FIG. 8 is an end view of the gripping apparatus of FIG. 7.

FIG. 9 is a top view of another gripping apparatus for a fork of a fork lift in accordance with the teachings of the present disclosure, the gripping apparatus shown operatively associated with a fork.

### DESCRIPTION OF VARIOUS ASPECTS

The following description is merely exemplary in nature and is not intended to limit the present disclosure, application, or uses. It should be understood that throughout the drawings, corresponding reference numerals indicate like or corresponding parts and features.

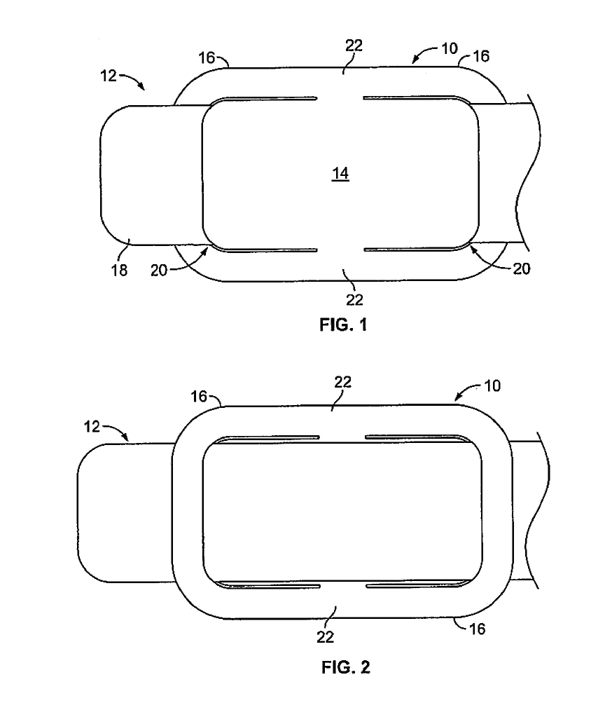

With general reference to FIGS. 1 through 4 of the drawings, a gripping apparatus in accordance with the teachings of the present disclosure is illustrated and identified at reference character 10. In FIGS. 1 through 3, the gripping apparatus 10 is shown operatively associated with a fork 12 of a fork lift. It will be understood that a fork lift having two forks may include a gripping apparatus 10 on one or both of the forks. The manner of attachment to the fork 12 will become apparent below.

The gripping apparatus 10 may generally include a gripping portion 14 and one or more mounting portions 16. The gripping portion 14 may be positioned proximate an upper side 18 of the fork 12. The gripping portion 14 may be constructed of a material having a coefficient of friction substantially greater than a coefficient of friction of the fork 12.

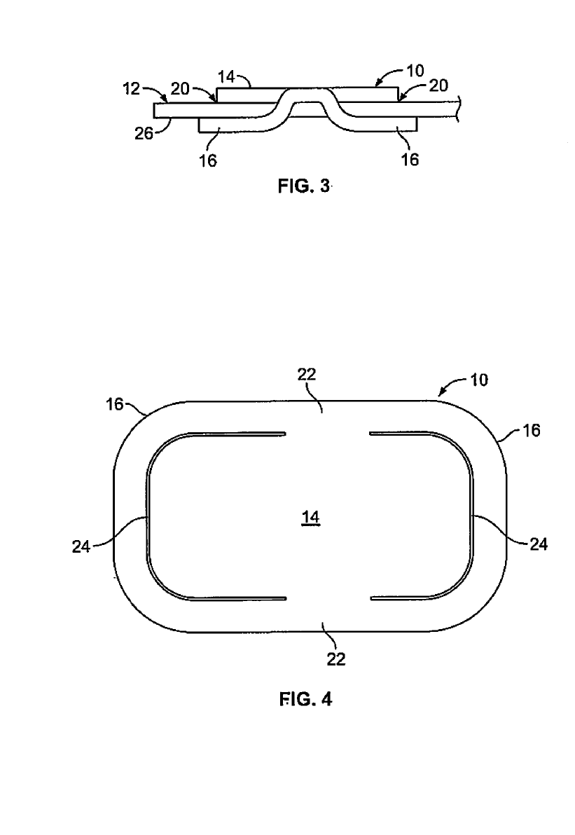

As shown throughout the drawings, the one or more mounting portions 16 may include first and second mounting portions 16. In other applications, the mounting portions 16 may be three or more in number. The gripping portions 16 may be integrally formed with the gripping portion 14. As perhaps best shown in the side view of FIG. 3, openings 20 may be defined between the gripping portion 16 and the mounting portions 16 for receiving the fork 12 of the fork lift.

The mounting portions 16 may extend around a portion of the periphery of the gripping portion 14. The mounting portions 16 may connect to the gripping portion 14 at intermediate portions 22. Slots 24 (see FIG. 4, for example) may extend between the gripping portion 14 and the mounting portions 16.

The gripping apparatus 10 may be unitarily constructed of a flexible material having a high coefficient of friction. While other materials may be used, one suitable material is rubber such as Neoprene. The slots 24 may be formed with a water jet or with any other suitable process well known to those skilled in the art. In other applications, the gripping apparatus 10 may be constructed of multiple materials. In this regard, contact surfaces may be constructed of a high friction material and other portions may be constructed of alternative material.

The flexible nature of the gripping apparatus 10 allows the apparatus 10 to be configured in a first orientation and a second orientation. In the first orientation, the gripping apparatus 10 is substantially planar. In this regard, the mounting portions 16 reside in substantially the same plane as the griping portion 14. The planar orientation facilitates storage and shipping of the gripping apparatus 10.

In a second orientation, the gripping apparatus 10 is configured to receive the fork 12 of the fork lift. In this regard, the mounting portions 16 may be displaced downwardly such that the slots 24 create the openings 20 between the mounting portions 16 and the gripping portion 14. The mounting portions 16 may be positioned proximate an underside 26 of the fork 12.

The gripping apparatus 10 of the present teachings may be quickly and easily installed without the need for any tools. The gripping apparatus 10 is simply slid over the free end of the fork 12. An underside of the gripping portion 14 engages the upper side 18 of the fork and is held in place through friction. The mounting portions 16 engage the underside 26 of the fork 12 and are similarly held in place with friction.

When installed in the above described manner on the fork 12 of a fork lift, the gripping apparatus 10 may increase the gripping strength of the contact surface of the pallet or other load and thereby better facilitate transportation of the load. In this regard, where the forks 12 of the fork lift cannot sufficiently extend beneath a load to raise the load, the gripping apparatus 10 may be used to drag the load. In this manner, the load can be repositioned. Upon completion, the gripping apparatus 10 may be quickly and easily removed.

In the embodiment illustrated, the apparatus 10 is completely constructed of a high friction material. As such, the apparatus 10 may be installed on the fork 12 such that the portions 16 are above the fork 12 and function as gripping portions and such that the portion 14 is below the fork 12 and functions as a mounting portion.

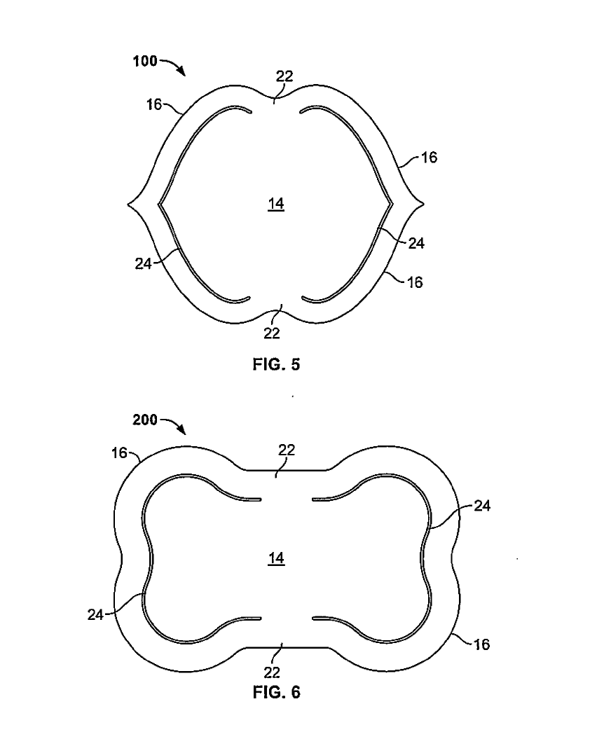

Turning to FIGS. 5 and 6, additionally gripping apparatuses constructed in accordance with the present teachings are illustrated and identified at reference characters 100 and 200. Given the similarities between the various embodiments, like reference characters are used to identify similar elements throughout the drawings. The gripping apparatus 100 is generally in the shape of a pair of lips. The gripping apparatus 200 is generally in the shape of a dog bone. The function and general construction of the apparatuses 100 and 200 will be understood to be identical to those described above with respect to apparatus 10.

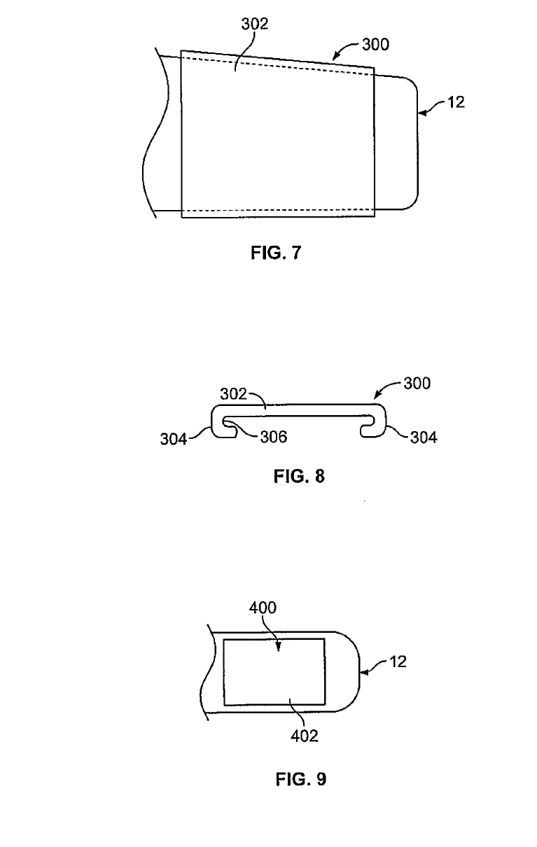

Turning to FIGS. 7 and 8, another gripping apparatus constructed in accordance with the present teachings is illustrated and identified at reference character 300. The gripping apparatus 300 may generally include a gripping portion 302 and one or more mounting portions 304. The gripping portion 302 may be positioned proximate an upper side 18 of the fork 12. The gripping portion 302 may be constructed of a material having a coefficient of friction substantially greater than a coefficient of friction of the fork 12.

As shown in the drawings, the one or more mounting portions 304 may include first and second mounting portions 304. As best shown in the side view of FIG. 7, a channel 306 may be at least partially defined by the gripping portion 302 and the mounting portions 304 for receiving the fork 12 of the fork lift. A cross section of the apparatus 300 may be generally C-shaped. The channel 306 may taper in a direction generally parallel to a longitudinal axis of the fork 12. In related embodiments, the mounting portions 304 need only extend along the sides of the fork 12 sufficiently to laterally engage the sides of the fork 12.

The flexible nature of the gripping apparatus 300 allows the apparatus 300 to be slid on an end of the fork 12 or the mounting portions 304 may be snapped about the edges of the fork 12. Turning to FIG. 9, another gripping apparatus constructed in accordance with the present teachings is illustrated and identified at reference character 400. The apparatus 400 includes an upper surface 402 and a lower surface. The upper surface 402 may be a high friction surface of Neoprene or other suitable material. At least a portion of the lower surface may be a magnetic surface to facilitate quick and easy attachment of the apparatus 400 to the fork 12.

In other embodiments within the scope of the present teachings, the apparatus 10 may be configured to alternatively attach to the fork 12. For example, the apparatus may define a sleeve that telescopically receives the fork 12. In still other embodiments, the apparatus may carry a male member (e.g., pin or the like) to be received within an aperture defined by the fork or vice versa.

While specific examples have been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. A gripping apparatus for a fork of a fork lift, the gripping apparatus comprising:
a gripping portion; and
at least one mounting portion for removably securing the gripping apparatus to the fork;
at least one opening formed between the at least one mounting portion and the gripping portion for receiving the fork therethrough;
wherein at least an upper surface of the gripping apparatus is constructed of a high friction material.

2. The gripping apparatus of claim 1, wherein the apparatus is constructed of Neoprene.

3. The gripping apparatus of claim 1, wherein the at least one mounting portion includes first and second mounting portions.

4. The gripping apparatus of claim 1, wherein the first and second mounting portions both extend about a periphery of the gripping portion.

5. The gripping apparatus of claim 3, wherein the gripping portion extends about the periphery of the at least one mounting portion.

6. The gripping apparatus of claim 3, wherein the first and second mounting positions are positionable a common plane with the gripping portion in a first configuration.

7. The gripping apparatus of claim 6, wherein the openings for receiving the fork are defined between the gripping portion and the mounting portions in a second configuration.

8. The gripping apparatus of claim 1, wherein the gripping portion is generally planar.

9. The gripping apparatus of claim 1, wherein the gripping apparatus is unitarily constructed of a high friction material.

10. The gripping apparatus of claim 1, in combination with the fork of the forklift, the fork passing through the at least one opening.

11. The gripping apparatus of claim 1, in combination with the fork of the fork lift, the gripping portion proximate one of an upper side and a lower side of the fork the at least one mounting portion positioned proximate the other of the upper side and the lower side.

12. The gripping apparatus of claim 1, in combination with the fork of the fork lift, the gripping portion positioned proximate an upper side of the fork and the mounting portion positioned proximate a lower side of the fork.

13. A gripping apparatus for a fork of a fork lift, the gripping apparatus comprising:
a gripping portion; and
at least one mounting portion cooperating with the gripping portion to at least partially define a channel for receiving the fork;
wherein the gripping apparatus is constructed of a high friction material.

14. The gripping apparatus of claim 13, wherein the apparatus is constructed of Neoprene.

15. The gripping apparatus of claim 13, wherein the at least one mounting portion includes first and second mounting portions.

16. The gripping apparatus of claim 15, wherein the gripping portion and the first and second mounting portions have a generally C-shaped cross section.

17. The gripping apparatus of claim 15, wherein the first and second mounting positions wrap around the fork.

18. The gripping apparatus of claim 15, wherein the first and second mounting portions extend down along at least a portion of the sides of the fork.

19. The gripping apparatus of claim 15, wherein the channel tapers in a direction parallel to a longitudinal axis of the fork.

20. A gripping apparatus for a fork of a fork lift, the gripping apparatus comprising:
a gripping portion having a first end and an opposite second end; and
a first mounting portion for removably securing the gripping apparatus to the fork, the first mounting portion proximate the first end;
a second mounting portion for removably securing the gripping apparatus to the fork, the second mounting portion proximate the second end;
a first opening formed between the first mounting portion and the gripping portion for receiving the fork therethrough;
a second opening formed between the second mounting portion and the gripping portion for receiving the fork therethrough; and
wherein at least an upper surface of the gripping apparatus is constructed of a high friction material.
